(19) United States
(12) Patent Application Publication
(10) Pub. No.: US 2024/0246734 A1
(43) Pub. Date: Jul. 25, 2024

(54) Vented Liner

(71) Applicant: Selig Grand Rapids LLC, Grand Rapids, MI (US)

(72) Inventor: Adam Jeffery Fisch, Dorr, MI (US)

(21) Appl. No.: 18/684,355

(22) PCT Filed: Aug. 17, 2022
(86) PCT No.: PCT/US2022/040576

§ 371 Date: Feb. 16, 2024

Related U.S. Application Data
(60) Provisional application No. 63/237,401, filed on Aug. 26, 2021.

(51) Int. Cl. B65D 53/04; B32B 3/08; B32B 3/26; B32B 5/18; B32B 15/04; B32B 15/09; B32B 15/20; B32B 27/06; B32B 27/32; B32B 27/36; B65D 51/16; B65D 65/40

(52) U.S. Cl. CPC B65D 53/04; B32B 3/08; B32B 3/266; B32B 5/18; B32B 15/046; B32B 15/09; B32B 15/20; B32B 27/065; B32B 27/322; B32B 27/36; B65D 51/1605; B65D 65/40; B32B 2307/31; B32B 2435/02; B32B 2581/00; B65D 2205/02

(57) ABSTRACT

A vented sealing member is provided for sealing to a rim of a container. The vented sealing member may provide for an exchange of fluid, such as gas, between an interior space of the container and the ambient atmosphere. This exchange may be necessary as pressure internal to the container may increase and/or decrease at various times, such as after manufacture and shipment. The vented sealing member is configured with a vent material on the sealing member opposite of the contents of the container.

### CROSS-REFERENCE TO RELATED APPLICATIONS

This application claims benefit of United States Provisional Application Number 63,237,401, filed Aug. 26, 2021, which is hereby incorporated herein by reference in its entirety.

### FIELD

The disclosure relates to sealing members for sealing to the rim of a container, and more particularly, to vented sealing members.

### BACKGROUND

It is often desirable to seal the opening of a container using a seal, sealing member, or inner seal. Often a cap or other closure is screwed or placed over the container opening capturing the sealing member therein. In use, a consumer typically removes the cap or other closure to gain access to the sealing member and then removes or otherwise peels the seal from the container in order to dispense or gain access to its contents. In some forms, the user may puncture the seal to gain access to the interior contents of the container.

Initial attempts at sealing a container opening utilized an induction- or conduction-type inner seal covering the container's opening where the seal generally conformed to the shape of the opening such that a circular container opening was sealed with a round disk approximately the same size as the opening. These prior seals commonly had a lower heat activated sealing layer to secure a periphery of the seal to a rim or other upper surface surrounding the container's opening. Upon exposing the seal to heat, the lower layer bonded to the container's rim. In many cases, these seals included a foil layer capable of forming induction heat to activate the lower heat seal layer.

However, problems still arise with sealing members when the contents of the container require pressure equalization. Sealed gas-tight containers require venting when gas pressure must be equalized between the interior and exterior of the container. Without venting, a flexible gas-tight container will bloat, leak, and possibly burst when the interior pressure exceeds the exterior pressure. Bloating can occur when the contents of the container generates gasses or heat by chemical reaction, for example when the contents include a peroxide-based toothpaste. Bloating can also occur when the container is stored in a heated environment. Similarly, an unvented flexible gas-tight container will collapse when the internal pressure is reduced, for example when atmospheric oxygen is scavenged by one of the ingredients housed in the container. Some modes of transportation put a container at risk of both bursting and collapse. During transport through mountains and valleys, for example, a container is subjected to pressures that can rise above and drop below sea level pressure. Rigid gas-tight containers, such as glass containers, are susceptible to bursting or imploding if the internal and external pressures become sufficiently discrepant.

One way to equalize pressure is to provide a filter vent in the cap, lid, or other closure of a container. Filter vents generally include a gas-permeable filter, or other gas permeable microporous medium, which is interposed between the interior of the container and a vent aperture. The filter vent permits gases to diffuse in and out of the interior of the container, via the vent aperture, while excluding particulates larger than a threshold size, as well as liquids of a particular range of hydrophobicity.

However, filter caps have other drawbacks. The pores of the filter are susceptible to being filled and clogged by the contents of the container. Further, the filter can make it difficult to puncture the seal. This may be a result of the added layers of the filter material, the filter material itself, and/or the adhesives used to secure the filter to the sealing member. This can be especially problematic when a user desires to precisely dispense the contents of the container if the sealing member is pierced and jagged remnants of the sealing member and filter remain on the container.

Further, depending on the properties of the contents of the container, the contents themselves can easily block, clog, or otherwise render the vent deficient. For example, materials with high viscosity, high tackiness, and other similar properties are more prone to clogging vents. Such materials can come into contact with the vent, such as during manufacture, transport, and the like, such that once they come into contact, they are not easily removed from the vent.

### SUMMARY

In one form, the present application proceeds contrary to conventional wisdom. Prior venting caps and seals would traditionally increase the size of the vent to minimize the impact of the contents on the vent function. It was previously thought that by increasing the surface area of the vent, the likelihood of the vent being entirely blocked would decrease. Similarly, prior systems incorporated the vent material or layer on an underside of the seal and oftentimes also included a cover over a portion of the vent. In this regard, it was previously thought that the cover helped prevent the contents of the container from contacting the vent.

The present concept, on the other hand, proceeds contrary to this conventional wisdom and can achieve improved performance compared to prior venting systems. In one form, the vent material is positioned on an opposite side of the sealing member and/or support member from the contents of the container. Further, the sealing member and/or support member can be used to define a vent opening to prevent contact between the contents and the vent material. The vent opening can be configured to be small, especially compared to many prior vent openings. By doing this, pressure can be concentrated on a much smaller surface area to clear any clogs from the vent opening and/or vent material.

In some forms, a vented sealing member for sealing to a rim of a container is provided. The vented sealing member includes a support member, a sealant layer, and a vent layer. The support member can include at least one layer with the support member defining a vent opening extending from a lower surface to an upper surface through the support member. The sealant layer can be positioned on the lower surface of the support member for securing the vented sealing member to the rim of the container. The vent layer can be positioned over the vent opening and coupled to the upper surface of the support member.

According to some forms, a laminate for forming a vented sealing member for sealing to a rim of a container is provided. The laminate includes a support member, a sealant layer, and a vent layer. The support member can include at least one layer with the support member defining a vent opening extending from a lower surface to an upper surface through the support member. The sealant layer can be positioned on the lower surface of the support member for securing the vented sealing member to the rim of the container. The vent layer can be positioned over the vent opening and coupled to the upper surface of the support member.

In accordance with some forms, a method of forming a vented sealing member for sealing to a rim of a container is provided. The method includes the steps of providing a support member having at least one layer, the support member having a lower surface and an upper surface, forming a vent opening extending from the lower surface to the upper surface through the support member, and positioning a vent layer over the vent opening and coupling the vent layer to the upper surface of the support member.

In some forms, the vent layer is welded to the upper surface of the support member.

According to some forms, the vent opening has a diameter of about 0.005 to 0.060 inches.

In some forms, the vent opening has an exposed surface area of about 0.00070 to about 0.0282 square inches.

In accordance with some forms, the vent opening has an exposed surface area that is about 80% or less of the vent material effective filter area.

According to some forms, the vent opening has an exposed surface area that is about 30% or less of the vent material effective filter area.

In accordance with some forms, the support member is a laminate comprising a plurality of layers.

According to some forms, the support member comprises at least one of a polymer film, a polymer foam, a metal foil, a pulp material, paper, and combinations thereof.

In some forms, the sealing member further includes an upper laminate partially coupled to the support member and defining a tab.

In accordance with some forms, the vent layer comprises expanded polytetrafluoroethylene.

In some forms, the sealing member includes a foil liner where an ePTFE vent material is welded to the back side of the liner, opposite the induction foil layer. Such a vent material could be welded onto a foam side of the sealing member.

According to some forms, the combination of a small vent hole and ePTFE vent material facing away from the contents of the container allows for thick viscous products to be cleared from the vent hole and ePTFE vent material when pressure returns into the sealed package. The vent layer prevents product from escaping and allows for sterile air to return into the container.

In some forms, the sealing members may be used with products that are thick and viscous. Typically, such products will coat the vent material and prevent pressure equalization. Many of these products are normally hot filled and when the product cools within the sealed container the pressure within the container will drop causing the container to panel. Using the sealing members described herein may allow the containers to vent products that normally do not have a suitable vented solution. Exemplary materials include, but are not limited to, motor oil, hair conditioner, shampoo, car wax, laundry detergents, liquid soap, nail polish cleaner, industrial cleaning products, pet foods, floor cleaner/wax, hand/body lotions, and the like.

These and other aspects may be understood more readily from the following description and the appended drawings.

### BRIEF DESCRIPTION OF THE DRAWINGS

FIG. 1 is a perspective view of one form of a vented sealing member;

FIG. 2 is a is an exploded view of a vented sealing member, container, and cap;

FIG. 3 is a perspective view of a vented sealing member with the vent material removed to illustrate the vent opening;

FIG. 4 is a cross-sectional view of a support member with a vent material applied thereto;

FIG. 5 is a cross-sectional view of another vented sealing member;

FIG. 6 is a cross-sectional view of another vented sealing member; and

FIG. 7 is a perspective view of a vented sealing member with a tab.

### DETAILED DESCRIPTION

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

A vented sealing member for sealing to a container is provided herein. In further forms, a tabbed and vented sealing member for a container is described herein containing an upper portion having a pull tab bonded to a lower portion capable of being sealed to a container's mouth or opening. In other forms, the various sealing members may be sealed via a pressure sensitive sealant layer. It should also be appreciated that the sealing member may have an external tab, extending outward beyond the lid of the container and/or may be a tab-free sealing member.

For simplicity, this disclosure generally may refer to a container or bottle, but the sealing members herein may be applied to any type of container, bottle, package or other apparatus having a rim or mouth surrounding an access opening to an internal cavity. In this disclosure, reference to upper and lower surfaces and layers of the components of the sealing member refers to an orientation of the components as generally depicted in figures and when the sealing member is in use with a container in an upright position and having an opening at the top of the container. Different approaches to the sealing member will first be generally described, and then more specifics of the various constructions and materials will be explained thereafter.

It should be appreciated that the vented sealing members described herein may be used in a variety of different types of sealing members. For example, the vented sealing members may take the form of an induction sealing member, a conduction sealing member, a pressure sensitive adhesive sealing member, as well as other types of sealing members. The vented sealing members may also be in the form of a foam liner or sealing member, a flexible film, and the like. The vented sealing members may also include one or more tabs for removal of the sealing member.

It should also be appreciated that the vented sealing members described herein may be used in a variety of configurations with a variety of different combinations of layers. For example, the sealing members may include polymer foams, films, coextrusions, foils, membranes, adhesives, paper, cardboard, as well as other materials that are used in sealing members. The thicknesses and positions of each of the layers may be modified as desired for a particular application.

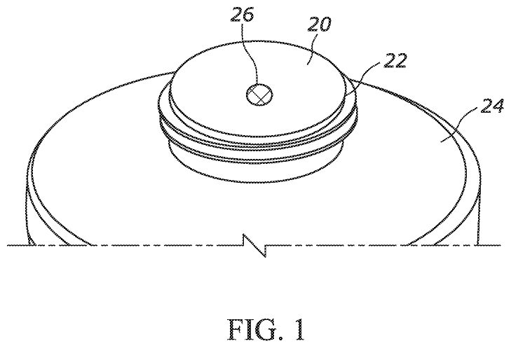

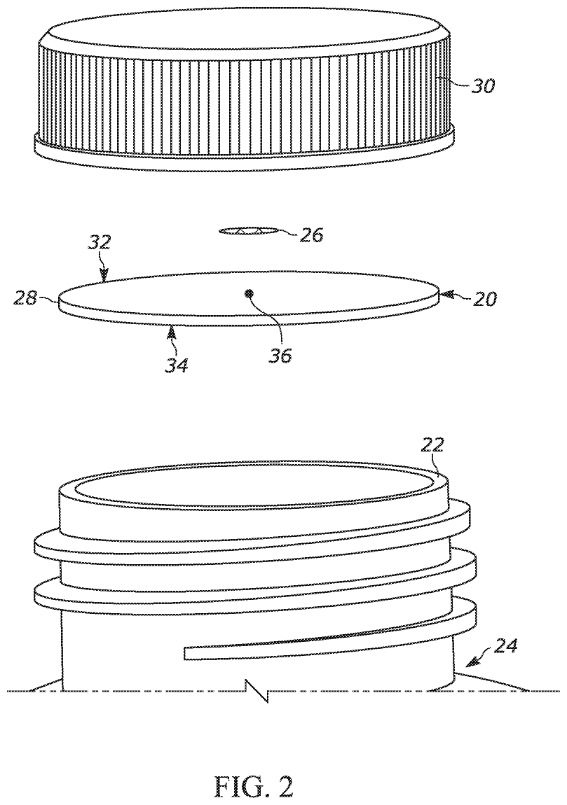

As shown in FIG. 1, a vented sealing member 20 is shown installed on a rim 22 of a container 24. The vented sealing member 20 includes a vent material 26 installed on a support member 28. FIG. 2 illustrates an exploded view of the sealing member 20 with the container and a cap 30. As shown in this figure, the vent material 26 is positioned at an upper surface 32 of the support member 28, opposite a lower surface 34.

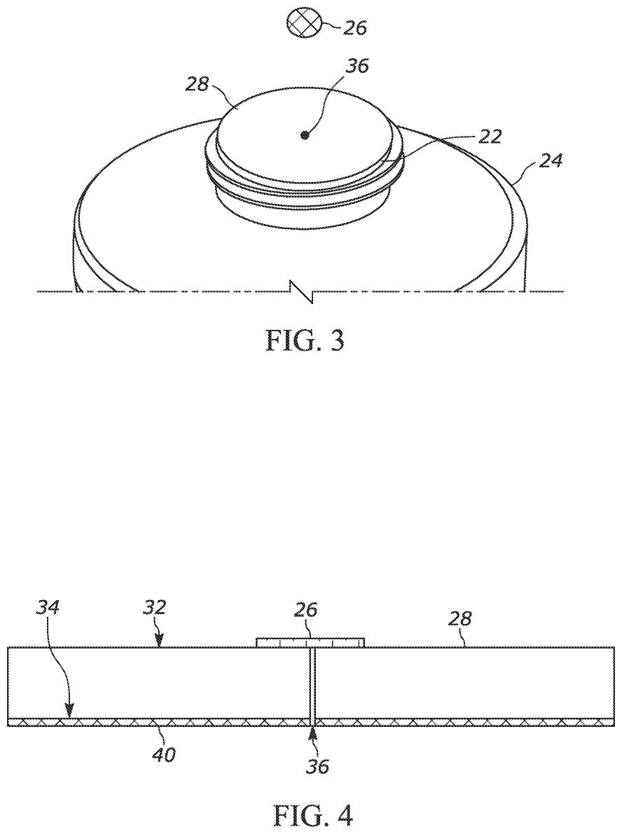

Turning to FIG. 3, it can be seen that the support member 28 defines a vent opening 36. The vent opening extends from the lower surface 34 to the upper surface 32 of the support member 28. The vent opening generally permits fluids, such as gases to pass between the vent material 26 and an interior of the container 24 when the sealing member 20 is installed.

As shown in FIG. 4, the vent material 26 is installed such that it surrounds the vent opening 36 at the upper surface 32. In this form, the vent material 26 would have decreased contact with the contents of the container. Further, the vent material 26 is installed, such as by welding, so that there are no gaps in the contact between the vent material 26 and the upper surface 32 to prevent gas from escaping anywhere except through the vent material 26. It should be appreciated that the surface area of the vent material 26 may be varied along with the surface exposure or diameter of the vent opening 36. The vent material 26 may also be secured at a peripheral edge thereof or at a location closer to the vent opening 36.

The sealing member 20 may also include a sealant layer 40 on the lower surface 34 of the support member 28. The sealant layer 40 may take the form of a layer that covers the entire surface area of the lower surface 34. In this form, the vent opening 36 would also extend through the sealant layer 40. In some forms, the sealant layer 40 may cover just a portion of the surface area of the lower surface 34 such as just at the periphery thereof. In this form, it would be unnecessary for the vent opening 36 to extend through the sealant layer 40.

Further discussion regarding some of the above-described components and details thereof will be provided below. The support member 28 may be a single layer, multiple layers, combinations of different materials, and combinations thereof. In one form, the support member 28 may be a single layer comprising a single material and in other forms it may be a single layer comprising a combination of materials.

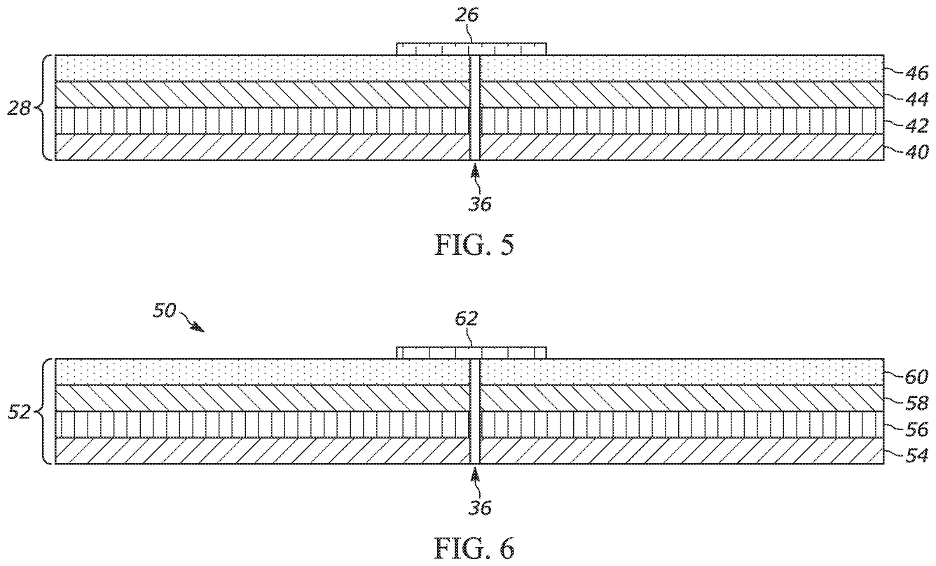

In some forms, the support member 28 may include a plurality of layers with varying components in each layer. For example, referring to FIG. 5, the support member 28 includes the sealant layer 40, a membrane layer 42, a support layer 44, and an insulating layer 46. It should be appreciated that the position, number, combination, and configuration of these layer may be modified as needed for a particular application.

The membrane layer 42 may be provided for barrier properties, such as oxygen and moisture barrier. The membrane layer 42 may also provide induction heating, such as in the form of a metal foil or other inductive material. The support layer 44 may also provide a variety of functions such as supporting other layers, insulation, adhesion between layers, and the like. The insulating layer 46 may also provide various functions such as insulation, compressibility (such as during cap installation), as well as providing a suitable surface to adhere to other components, such as the vent material.

One form of a vented sealing member 50 is shown in FIG. 6. In this form, the sealing member 50 includes a support member 52 having a plurality of layers. The sealing member 50 includes a sealant layer 54, an induction heating layer 56, a polymer film 58, a polymer foam 60, and a vent material layer 62.

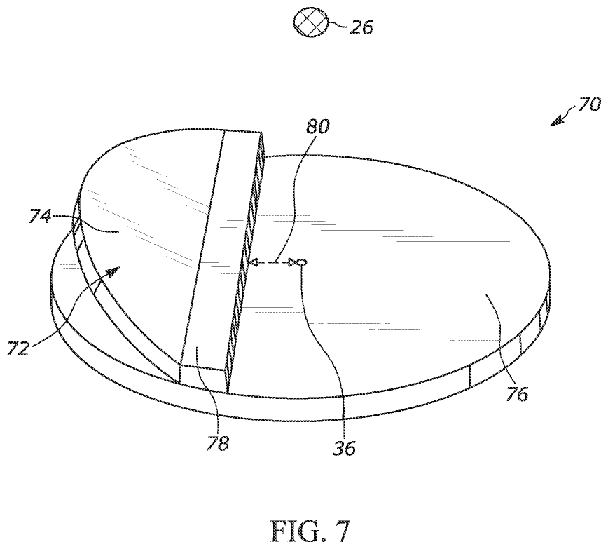

Yet another form of sealing member 70 is shown in FIG. 7. This view shows the vent material 26 exploded from the sealing member 70 to better illustrate the placement of the vent opening 36. Sealing member 70 is generally considered a tabbed sealing member as it includes a tabbed portion 72 to enable a user to grasp the tabbed portion 72 and remove the sealing member 70 from a container.

Sealing member 70 includes many of the same features as discussed above, but includes an upper portion 74 that is partially adhered to a support member 76. The tabbed portion 72 is provided by having the upper portion 74 partially adhered to the support member 76, such as at adhered portion 78. To ensure proper venting function, the upper portion 74 should be offset from the vent opening 36, by a distance, such as represented by arrow 80. This ensures that the vent opening 36 is not covered by any the upper portion 74. Further, the distance 80 permits the vent material 26 to have adequate space to be coupled to the support member 76 about the vent opening 36. Alternatively, the vent opening 36 and/or vent material 26 can be positioned beneath the tabbed portion 72, but not the adhered portion 78.

It should be appreciated that the number and type of layers can be modified as discussed above. Further, in some forms, the support members may include a single layer, two layers, three layers, four layers, five layers, etc. For example, the support member may include an induction heating layer, such as a metal foil layer, and a polymer film and/or polymer foam layer. In this regard, the induction heating layer can be used in an induction process to provide heat to the sealant layer and the polymer film and/or polymer foam layer can be used as a surface for installing the vent material. In other forms, only a polymer film and/or polymer foam layer may be used without the induction heating layer.

The support member may include a variety of materials, such as discussed above. These materials include, but are not limited to, adhesives, polymer foams, polymer films, induction heating materials such as metal foils, paper, pulp, and the like.

As described above, the vent opening extends from the lower surface to the upper surface of the support member. In this form, the vent opening provides a passageway for fluid, such as gas, air, and the like, to flow into and/or out of the container. The vent opening can be formed to have a variety of different sizes. When in the form of a generally circular cross-section, the vent opening can have a diameter of from about 0.005 to about 0.060 inches. In other forms, the vent opening can have a diameter of from about 0.005 to about 0.250 inches. It should be appreciated that depending on the method of forming the vent opening, the size and shape may not be perfectly symmetrical or perfectly follow the desired shape. For instance, the support member may include flexible material that stretches or shift during manufacture such that the vent opening may not have a perfect geometric shape. In this regard, it may be necessary to use a larger punch to create the vent opening than desired. When determining the vent opening size, the widest point of the opening may be used.

In some forms, the exposed area of the vent opening may be used to determine relative size of the opening. For example, the area of the vent opening may be about 0.00070 to about 0.0282 in². In some forms, larger vent openings may be used, depending on the choice of vent material, vent material size, and/or fluid properties of the contents of the container.

The vent opening can take a variety of shapes, sizes, forms, and the like. In some forms, the vent opening has a generally circular cross-section such that the vent opening is generally cylindrical. The vent opening can take other shapes and configurations, such as depending on how the vent opening is formed. Other shapes include, but are not limited to, square, rectangular, diamond, trapezoid, oval, round, and the like.

Depending on the configuration of the sealant layer and the support member, the vent opening may extend through the sealant layer and the support member. For example, when the sealant layer is configured to extend over the entire surface area of the lower surface of the support member, the vent opening would be configured to also extend through the sealant layer. In other forms, such as when the sealant layer does not extend over the entire surface area of the lower surface, it may not be necessary to have the vent extend through the sealant layer.

Further, the vent opening may be configured in any orientation relative to the sealing member. For example, the vent opening may be configured to extend substantially vertical (perpendicular to the lower and upper surfaces). In other forms, the vent opening may be configured to extend at a different angle that is not vertical.

The vent opening can be implemented in a variety of manners. For example, the vent opening can be created by using a punch that creates the opening in the support member. The shape, size, angle, tip, and other properties of the punch may be modified to achieve the desired vent opening shape and characteristics. Other methods may also be used, such as through a laser, hot tip lance, blade cutting, perforating, and the like.

As described above, the vent material can be in a form of a layer that that is positioned over the vent opening. On the upper surface of the support member. The vent material can be a full layer or a partial layer, relative to the size and shape of the upper surface of the support member. In some forms, the vent material is a partial layer that is secured to the upper surface of the support member about the vent opening. In some forms, the vent material may have a diameter of from about 0.19 inches to about 0.50 inches. In some forms, the vent material has a diameter of 3.2 mm, 4.8 mm, 6.4 mm, or 8.9 mm.

The vent material composition can include a variety of different materials to provide the desired venting function. The vent material may comprise a single layer, multiple layers, coatings, and the like. For example, in some forms, the vent material may have a base material, such as an ePTFE material that is then coated on at least one side thereof. In some forms, the vent may include a backing material or may be backless such that just ePTFE is provided.

The vent material choice may also be impacted by the contents of the container. For instance, certain liquids may be more suitable for use with certain types of vent materials. Such vent materials may include, but are not limited to, ePTFE materials, PVDF, nitro cellulose membranes, synthetic paper, and the like. Exemplary materials include, but are not limited to the following: 0.02 micron ePTFE—NW PET backer—oleophobic and hydrophobic coatings, 0.45 micron ePTFE—NW PET backer—oleophobic and hydrophobic coatings, 0.02 micron ePTFE—NW PP backer—oleophobic and hydrophobic coatings, 0.45 micron ePTFE—NW PP backer—oleophobic and hydrophobic coatings, 0.7 micron ePTFE—NW PP backer—oleophobic and hydrophobic coatings, 0.02 micron ePTFE—NW PP/PET backer—oleophobic and hydrophobic coatings, 0.45 micron ePTFE—NW PP/PET backer—oleophobic and hydrophobic coatings, 0.7 micron ePTFE—Delnet backer—oleophobic and hydrophobic coatings, 0.05 micron ePTFE—NW PET backer—oleophobic and hydrophobic coatings, 0.05 micron ePTFE—NW PP backer—oleophobic and hydrophobic coatings, and the like. Other backless forms may also be used.

The vent material may be installed in a variety of different manners, for example, depending on the vent material as well as the upper surface of the support member, the vent material may be installed by ultrasonic welding, adhesives, heat staking, and the like. It should be appreciated that in some forms, the backer and support layers are used to secure the vent material to the support member. Further, this permits the vent material to be secured directly to the liner compared to prior vents where the vent material is adhered to a lower silicon layer below the support member with the silicon layer being used to secure the vent material to the lower side of the sealing member.

The vent opening and vent material may be combined and modified to achieve suitable venting and clearing of the vent material and vent opening. For example, for vents with an effective filter area of 0.125″ for the filter material, the vent opening can include a vent opening of 0.0413″ or smaller, but some may include vent openings with sizes up to 0.100″. For intermediate vent material layers with effective filter area of 0.160″ the vent opening may have a size of 0.528″ (⅓), with decreasing performance up to a hole size of 0.128″. It should be appreciated that, in some forms, the data does trend towards smaller ratios having a bigger advantage with thicker liquids.

In some forms, it may be preferable to have our hole size less than 30% of the vent material effective filter area, but with the understanding there are still some significant advantages to vent opening sizes all the way up to 80% or more of the vent's effective filter area. Smaller hole size to vent ratios tend to perform equally or better to this point.

The sealant layer may be selected from a variety of different sealing materials. For example, the sealant layer may be a heat activated bonding layer. In this form, the sealant layer may be heated through induction, conduction, and the like. The sealant layer may also take other forms such as pressure sensitive adhesive and the like.

One exemplary form of a vented sealing member includes about 0.015 inch thick heat seal, 0.0005 inch thick PET layer on the heat seal, a 0.001 inch thick aluminum foil layer on the PET, 0.007 inch thick polymer foam material on the aluminum foil layer, and an ePTFE vent material welded thereto. The vent opening is 0.040 inches. The polymer foam material may be thicker and may include a coextruded film to increase the thickness.

Another exemplary vented sealing member is similar to the above, but includes the ePTFE vent material adhered directly to the foil material without intermediary polymer foam layer. In this form, the vent material can be applied by adhering to a polymer film layer, such as PET.

In some forms, it may be desirable to have the vent material applied PET, PP, or PE film layer, such as on the upper surface of the support member. Depending on the installation technique it may be desirable to have a somewhat thicker upper surface, such as about 0.001 to about 0.020 inches thick. This allows for a proper weld of the vent material to the liner. In some forms, depending on the particular upper surface material, a layer of 0.0005 inches was too thin and welding the vent material would melt through and create small pinholes within the weld allowing for product to pass through the vent material at the weld. By using a slightly thicker upper surface layer, a much wider process window can be utilized for welding and production speeds improved. The quality of the weld also improved.

In some forms, it may be difficult to determine if the vent material is properly applied to the support member and is properly positioned over the vent opening. For example, when white vent material is applied to white support member, it may be difficult to automate quality control. In this regard, one or more of the upper surface of the support layer and the vent material may include a color, printing, and the like, as described below.

When the upper surface of the support member is white, the white color prevents some inspection systems from seeing the weld of the vent material on the surface of the support member. The inspection system visually inspects every vent during the manufacturing process and confirms vent placement, weld integrity, and proper cut of vent material. When the vent material is also white, the inspection system image did not have enough contrast to confirm the key features.

To overcome this issue, printed liners were attempted to provide some contrast. This provided an improvement in contrast and it was found that when the vents lined up with the lettering on the liner our camera could see the vent and performed the inspections. The use of a colorant in the PET layer was also utilized to provide the needed contrast. This provided needed contrast for visual inspections.

It should be appreciated that the combination of the small vent hole and ePTFE vent material facing away from the product in the container allows for thick viscous products to be cleared from the vent hole and ePTFE vent material when pressure returns into the sealed package. The vent layer prevents product from escaping and allows for sterile air to return into the container. The present concept proceeds contrary to conventional wisdom by maintaining a small opening and positioning the vent material on an opposite side of the liner. As noted above, conventional wisdom would have increased the surface area of the vent material exposed to the contents of the container. Instead, by having a focused and small area, the pressure is able to direct liquids from the vent material and away from the vent opening.

As noted above, the concepts described herein may be especially suitable with applications were the product is thick and viscous. Typically, products like this will coat the vent material and prevent pressure equalization. Such products are often hot filled and when the product cools within the sealed container, the pressure within the container will drop causing the container to panel. Exemplary materials include, but are not limited to, motor oil, hair conditioner, shampoo, car wax, laundry detergents, liquid soap, nail polish cleaner, industrial cleaning products, pet foods, floor cleaner/wax, hand/body lotions, and the like.

It should be appreciated that the layers in the support member and the sealant layer can be selected to work with a variety of different containers. For example, containers made from HDPE, PET, glass, LDPE, nylon, pulp board, acrylic, metal, phenolic, and the like may be used.

Additional layers may be included in the upper (tabbed portion) and/or lower laminate (support member) such as polyethylene terephthalate (PET), nylon, or other structural polymer layer and may be, in some approaches, about 0.5 to about 1 mil thick. In some approaches, additional layers may be included in the lower laminate. It should be appreciated that the lower seal laminate may include any number of other layers, such as polymer layers, adhesives, polymer films, polymer foams and the like.

The polymer layers used in the upper and/or lower laminates may take a variety of forms such as coatings, films, foams, and the like. Suitable polymers include but are not limited to, polyethylene, polypropylene, ethylene-propylene copolymers, blends thereof as well as copolymers or blends with higher alpha-olefins. By one approach, one or more of the polymer layers may be a blend of polyolefin materials, such as a blend of one or more high density polyolefin components combined with one or more lower density polyolefin components. In one form, one polymer layer may be a polyethylene film while another polymer layer may be a PET film. According to one form, the polyethylene film may have a thickness of about 5 to about 20 microns while the PET film may have a thickness of about 5 to about 20 microns.

A further support layer may be optional in the laminate. If included, it may be polyethylene terephthalate (PET), nylon, or other structural polymer layer and may be, in some approaches, about 0.5 to about 1 mil thick.

The membrane layer may be one or more layers configured to provide induction heating and/or barrier characteristics to the seal. A layer configured to provide induction heating is any layer capable of generating heat upon being exposed to an induction current where eddy currents in the layer generate heat. By one approach, the membrane layer may be a metal layer, such as, aluminum foil, tin, and the like. In other approaches, the membrane layer may be a polymer layer in combination with an induction heating layer. The membrane layer may also be or include an atmospheric barrier layer capable of retarding the migration of gases and moisture at least from outside to inside a sealed container and, in some cases, also provide induction heating at the same time. Thus, the membrane layer may be one or more layers configured to provide such functionalities. By one approach, the membrane layer is about 0.3 to about 2 mils of a metal foil, such as aluminum foil, which is capable of providing induction heating and to function as an atmospheric barrier.

In some forms, the seals may include an insulation layer or a heat-redistribution layer. In one form, the insulation layer may be a foamed polymer layer. Suitable foamed polymers include foamed polyolefin, foamed polypropylene, foamed polyethylene, and polyester foams. In some forms, these foams generally have an internal rupture strength of about 2000 to about 3500 g/in. In some approaches, the foamed polymer layer 106 may also have a density less than 0.6 g/cc and, in some cases, about 0.4 to less than about 0.6 g/cc. In other approaches, the density may be from about 0.4 g/cc to about 0.9 g/cc. The foamed polymer layer may be about 1 to about 5 mils thick.

In other approaches, a non-foam heat distributing or heat re-distributing layer may be included. In such approach, the non-foam heat distributing film layer is a blend of polyolefin materials, such as a blend of one or more high density polyolefin components combined with one or more lower density polyolefin components. Suitable polymers include but are not limited to, polyethylene, polypropylene, ethylene-propylene copolymers, blends thereof as well as copolymers or blends with higher alpha-olefins. By one approach, the non-foam heat distributing polyolefin film layer is a blend of about 50 to about 70 percent of one or more high density polyolefin materials with the remainder being one or more lower density polyolefin materials. The blend is selected to achieve effective densities to provide both heat sealing to the container as well as separation of the liner from the seal in one piece.

The heat-activated bonding layer may include any polymer materials that are heat activated or heated to achieve its bonding characteristics or application to the seal. By one approach, the heat-activated bonding layer may have a density of about 0.9 to about 1.0 g/cc and a peak melting point of about 145° F. to about 155° F. A melt index of the bonding layer 120 may be about 20 to about 30 g/10 min. (ASTM D1238). Suitable examples include ethylene vinyl acetate (EVA), polyolefin, 2-component polyurethane, ethylene acrylic acid copolymers, curable two-part urethane adhesives, epoxy adhesives, ethylene methacrylate copolymers and the like bonding materials.

The adhesives useful for any of the adhesive or tie layers described herein include, for example, ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials. Other suitable materials may include low density polyethylene, ethylene-acrylic acid copolymers, and ethylene methacrylate copolymers. By one approach, any optional adhesive layers may be a coated polyolefin adhesive layer. If needed, such adhesive layers may be a coating of about 0.2 to about a 0.5 mil (or less) adhesive, such as coated ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials.

In one aspect, the tab may be formed by a partial layer of material combined with a partial width composite adhesive structure that includes a polyester core with upper and lower adhesives on opposite sides thereof. This partial composite adhesive structure bonds the upper laminate to the lower laminate to form the gripping tab.

In other aspects of this disclosure, the upper portion of the seal does not extend the full width of the sealing member in order to define the gripping tab. To this end, the pull-tab sealing members herein may also combine the advantages of a tabbed sealing member with a large gripping tab defined completely within the perimeter of the seal, but achieve such functionality with less material (in view of the part layers of the upper laminate) and permit such a tab structure to be formed on many different types of pre-formed lower laminates. The partial upper laminate structure is advantageous, in some approaches, for use with a seal configured for large or wide mouth containers, such as containers with an opening from about 30 to about 100 mm (in other approaches, about 60 to about 100 mm). These seals may also be used with 38 mm or 83 mm container openings, or can be used with any sized container.

In further aspects of this disclosure, the sealing members herein may include a pull or grip tab defined in the upper portion wholly within a perimeter or circumference of the sealing member wherein an upper surface of the sealing member is partially defined by the upper portion and partially defined by the lower laminate portion. In one approach of this aspect, the top surface of the sealing member is provided by a minor portion of the upper laminate and a major portion of the lower laminate. In other approaches of this aspect, the lower laminate is partially exposed at a top surface of the seal with about 50 percent to about 75 percent (or more) of the lower laminate exposed at the top surface of the entire seal.

In the various embodiments, the seals of the present disclosure defining a tab wholly within a perimeter or circumference of the seal (formed by a full or partial layer) also provide an improved ability for the tabbed sealing member to function in a two-piece seal and liner combination. In a two-piece seal and liner combination, the tabbed sealing member is temporarily adhered across its top surface to a liner. After container opening and removal of a cap or closure, the sealing member stays adhered to the container mouth and the liner separates and remains in the container's cap.

The various layers of the sealing member are assembled via coating adhesives, applying films, and/or a heat lamination process forming a sheet of the described layers. Extrusion lamination may also be used. The resulting laminate sheet of the sealing members can be cut into appropriately sized disks or other shapes as needed to form a vessel closing assembly or tabbed sealing member. The cut sealing member is inserted into a cap or other closure which, in turn, is applied to the neck of a container to be sealed. The screw cap can be screwed onto the open neck of the container, thus sandwiching the sealing member between the open neck of the container and the top of the cap. The sealing layer may be a pressure sensitive adhesive, the force of attaching the closure to the container can activate the adhesive.

The vented sealing members may be manufactured in a variety of different manners. In one form, the support member, typically also including the sealant layer, is provided to have the vent opening formed therein. As noted above, the support member can be worked by a punch, laser, and the like to create the vent opening extending therethrough. Once the vent opening has been created, the vent material can be applied to the support member over the vent opening. This can be done by welding, direct contact adhesives, pressure sensitive adhesives, thermal lamination, and the like. When a tabbed form of the vented sealing member is desired, the process is similar with the tab been applied to the support member either before or after the vent opening.

It should be appreciated that the combination of the vent hole and the orientation of the vented sealing member allows for venting function to work efficiently. Having the vent hole facing the product within the container limits product exposure to the vent material on the opposite side. This reduction in product exposure allows for most of the vent material to be clear of product. When the pressure within the container changes, the vent hole allows for the product to easily clear. The small gap between the vent material and vent hole reduces the brake pressure (the pressure required to clear the vent and allow for a free exchange of air).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

1. A vented sealing member for sealing to a rim of a container, the vented sealing member comprising:
a support member having at least one layer, the support member defining a vent opening extending from a lower surface to an upper surface through the support member;
a sealant layer positioned on the lower surface of the support member for securing the vented sealing member to the rim of the container; and
a vent layer positioned over the vent opening and coupled to the upper surface of the support member.

2. The vented sealing member of claim 1 wherein the vent layer is welded to the upper surface of the support member.

3. The vented sealing member of claim 1 wherein the vent opening has a diameter of about 0.005 to 0.060 inches.

4. The vented sealing member of claim 1 wherein the support member is a laminate comprising a plurality of layers.

5. The vented sealing member of claim 1 wherein the support member comprises at least one of a polymer film, a polymer foam, a metal foil, a pulp material, paper, and combinations thereof.

6. The vented sealing member of claim 1 further comprising an upper laminate partially coupled to the support member and defining a tab.

7. The vented sealing member of claim 6 wherein the vent opening is not positioned beneath the tab.

8. The vented sealing member of claim 6 wherein the vent opening is positioned beneath the tab.

9. (canceled)

10. A laminate for forming a vented sealing member for sealing to a rim of a container, the laminate comprising:
a support member having at least one layer, the support member defining a vent opening extending from a lower surface to an upper surface through the support member;
a sealant layer positioned on the lower surface of the support member for securing the vented sealing member to the rim of the container; and
a vent layer positioned over the vent opening and coupled to the upper surface of the support member.

11. The laminate of claim 10 wherein the vent layer is welded to the upper surface of the support member.

12. The laminate of claim 10 wherein the vent opening has a diameter of about 0.005 to 0.060 inches.

13. The laminate of claim 10 wherein the support member is a laminate comprising a plurality of layers.

14. The laminate of claim 10 wherein the support member comprises at least one of a polymer film, a polymer foam, a metal foil, a pulp material, paper, and combinations thereof.

15. The laminate of claim 10 further comprising an upper laminate partially coupled to the support member and defining a tab.

16. The laminate of claim 15 wherein the vent opening is not positioned beneath the tab.

17. The laminate of claim 15 wherein the vent opening is positioned beneath the tab.

18. (canceled)

19. A method of forming a vented sealing member for sealing to a rim of a container, the method comprising the steps of:
providing a support member having at least one layer, the support member having a lower surface and an upper surface;
forming a vent opening extending from the lower surface to the upper surface through the support member; and
positioning a vent layer over the vent opening and coupling the vent layer to the upper surface of the support member.

20. The method of claim 19 wherein the vent layer is welded to the upper surface of the support member.

21. The method of claim 19 wherein the vent opening has a diameter of about 0.005 to 0.060 inches.

22. (canceled)

23. The method of claim 19 wherein the support member comprises at least one of a polymer film, a polymer foam, a metal foil, a pulp material, paper, and combinations thereof.

24.-25. (canceled)
